(19) United States
(12) Patent Application Publication
(10) Pub. No.: US 2026/0327466 A1
(43) Pub. Date: Oct. 22, 2026

(54) CATIONICALLY CURABLE ADHESIVE WITH HOLDING-STRENGTH INDICATION

(71) Applicant: tesa SE, Norderstedt (DE)

(72) Inventors: Christian SCHUH, Norderstedt (DE); Sven HEIDSIECK, Norderstedt (DE); Oleg BRINSTER, Norderstedt (DE); Marten PAPENBROOCK, Norderstedt (DE)

(73) Assignee: tesa SE, Norderstedt (DE)

(21) Appl. No.: 19/115,618

(22) PCT Filed: Sep. 13, 2023
(86) PCT No.: PCT/EP2023/075108

§ 371 Date: Mar. 26, 2025

(30) Foreign Application Priority Data
Sep. 28, 2022 (DE) 10 2022 124 902.6

(51) Int. Cl. C09J 163/00; C09J 7/38; C09J 9/00; C09J 11/04; C09J 11/06

(52) U.S. Cl. CPC C09J 163/00; C09J 7/38; C09J 9/00; C09J 11/04; C09J 11/06; C09J 2301/10; C09J 2400/10; C09J 2400/20; C09J 2423/04; C09J 2463/00

(57) ABSTRACT

The invention relates to a curable adhesive comprising: a) one or more (co)polymers, b) one or more polymerizable epoxide compounds, c) one or more cationic initiators, and d) one or more pH colour indicators with at least one pH-dependent colour change, where the mass ratio of the combined mass of the cationic initiators to the combined mass of the pH colour indicators in the curable adhesive is 5:1 or more, and where the composition of the curable adhesive is such that a pH-dependent colour change of the one or more pH colour indicators takes place during the cationic curing of the curable adhesive at a moment at which the bond strength of the curing adhesive is in the range from 20% to 80% of the maximum bond strength achievable through the cationic curing.

The invention relates to a curable adhesive compound and to a reactive adhesive tape comprising such a curable adhesive compound and to an efficient method for connecting two or more components before carrying out further processing steps. Additionally disclosed are the use of such curable adhesive compounds and reactive adhesive tapes for bonding two or more components and a method for producing such curable adhesive compounds.

The joining of separate elements is one of the central methods in manufacturing. In addition to other methods, such as welding and soldering, for example, adhesive bonding, i.e. joining using an adhesive, is of particular importance nowadays. An alternative here to the use of formless adhesives which are applied from a tube, for example, are so-called adhesive tapes. From everyday life, pressure-sensitive adhesive tapes in particular are known, in which the adhesive effect is ensured by a pressure-sensitive adhesive compound which is permanently tacky and adhesive under normal ambient conditions. Corresponding pressure-sensitive adhesive tapes can be applied to a substrate by means of pressure and remain adhering there, but can later be removed in a more or less residue-free manner.

However, another type of adhesive tape is also of great importance, especially for use in industrial manufacturing. These adhesive tapes, which are sometimes also referred to as reactive adhesive tapes, use a curable adhesive. Appropriate curable adhesives have not yet reached their maximum degree of crosslinking in the state intended for application and can be cured by external influences, by initiating the polymerization in the curable adhesive and thereby increasing the degree of crosslinking. The mechanical properties of the now cured adhesive change here, with the viscosity, surface hardness and strength increasing in particular.

Curable adhesives are known in the art and can have very different compositions from a chemical point of view. These curable adhesives have in common that the crosslinking reaction can be triggered by external influencing factors, by supply of energy, for example, in particular by temperature, plasma or radiation curing, and/or by contact with a polymerization-promoting substance, as is the case, for example, with moisture-curing adhesives. Illustrative adhesives are disclosed for example in DE 102015222028 A1, EP 3091059 A1, EP 3126402 B1, EP 2768919 B1, DE 102018203894 A1, WO 2017174303 A1, JP 4611463 B2 and U.S. Pat. No. 4,661,542 A.

Despite the known advantages of curable adhesive compounds, they also have properties in processing that are perceived as disadvantageous. Since curable adhesive compounds generally achieve the necessary bond strength only in the course of curing, it is often necessary, when using curable adhesive compounds for bonding components, to wait for the curable adhesive compound to cure sufficiently before further processing of the component assemblies thus produced can take place. This applies in particular in cases where the component assembly produced is exposed to strong mechanical loads during further processing, which can cause a failure of the bond in the event of insufficient curing.

In practice, the problem described above is in many cases reinforced by the fact that the curing rate of curable adhesive compounds is generally not constant, but may instead depend on numerous factors. In addition to local variations in the chemical composition or environmental parameters, such as the ambient temperature and the air humidity, these factors include, in particular, an inconsistent activation of the curing, owing for example to a differential energy input in the context of radiation-based curing. However, since the bond strength already achieved cannot be easily determined, even for experienced workers, with conventional curable adhesive compounds, these uncertainties must in many cases be taken into account in that the period prior to further processing of a component assembly joined with the curable adhesive compound must as a precaution be made even longer, within the framework of a standardized manufacturing procedure, in order to be able to reliably rule out failure of the bond even in the event of retarded curing.

Because of the above-described aspects, the bonding of components with a curable adhesive compound can often become a time-determining step of such manufacturing processes, which adversely affects the time and cost efficiency.

In the area of adhesive technology, against this background, there is a continued interest in improving curable adhesive compounds and their use. In this respect, however, many development efforts are directed toward optimizing the basic curing rate and/or reducing its variance, which is usually achieved by an alteration in the chemical composition of the curable adhesive compounds. However, since the required physicochemical properties of such adhesive compounds are usually determined mostly by the respective application requirements, which relate essentially to the cured state, this approach has natural limits, since even the best curing characteristics of a curable adhesive compound offer only little advantage if the cured bond that can be produced with it does not meet the specified requirements.

In the prior art, the use of color indicators has been proposed, as for example in EP 3105276 B1. In the prior art, however, this use of color indicators initially served primarily to indicate successful activation of the curable adhesive compounds. Even if this may offer practical advantages, for the easy identification of faulty, unactivated adhesive compounds, for example, the problem described above is not thereby improved.

In WO 2020119898 A1, curable adhesive compounds are disclosed to which a dye, more particularly azo dyes or Sudan blue, is added and which, as a result, not only show a color change after the activation of the adhesive compound but also show a new color change after reaching the final bond strength, in the case of WO 2020119898 A1 after 24 h. This makes it possible to reduce the time buffer described above to ensure complete curing despite the variance in the curing rate, since the achievement of the final bond strength can be visually recognized by the workers employed.

In the estimation of the inventors of the present invention, however, the technology disclosed in WO 2020119898 A1 is not optimally suited in view of the practical framework conditions and requirements of modern manufacturing processes. In particular, the achievable degree of increase in the time and cost efficiency of the process regime is perceived as requiring improvement.

The primary object of the present invention was to eliminate or at least reduce the above-described disadvantages of the prior art.

In particular, the object of the present invention was to specify a curable adhesive compound with which the bonding of components can be accomplished with increased time and cost efficiency.

In addition, it was an object of the present invention that reliable bonding of the components and a high process reliability during application should be possible with the curable adhesive compound, especially even when using untrained workers.

It was a further object of the present invention that the curable adhesive compound to be specified should have the greatest possible flexibility with regard to the chemical composition and thus with regard to the physicochemical properties achievable in the course of curing, in particular with regard to the achievable peel adhesion. In particular, the curable adhesive compound to be specified should predominantly be producible even from components that are used for conventional curable adhesive compound. In addition, the curable adhesive compound should desirably be implementable both as a liquid and as a solid, pressure-sensitive adhesive compound.

It was a supplementary object of the present invention to provide an advantageous reactive adhesive tape or pressure-sensitive adhesive tape.

It was an additional object of the present invention to specify an efficient method for connecting two or more components before carrying out further processing steps.

In addition, it was a secondary object of the present invention to provide a use of the curable adhesive compounds or reactive adhesive tapes to be specified for bonding two or more components and a method for producing such curable adhesive compounds.

The inventors of the present invention have now found that the above-described objects can be achieved, surprisingly, if in epoxy-based curable adhesive compounds which cure via a cationic initiator, a color indicator is used that is selected in tune with the rest of the composition of the curable adhesive compound in such a way that the curable adhesive compound shows a color change when the bond strength is in the range from 20% to 80% of the maximum bond strength achievable by the cationic curing, as defined in the claims.

The invention is based on the surprising finding that, according to the estimation of the inventors, the solution found in WO 2020119898 A1, which the inventors certainly also estimate will have its fields of application, placed rather the wrong focus with regard to the practical framework conditions and requirements of modern manufacturing processes, so ultimately preventing a particularly advantageous increase in the time and cost efficiency of the process regime, of the kind which becomes possible within the scope of the present invention.

Without wanting to be bound by this theory, it is assumed that the concentration of the cationic initiator or the concentration of the curing-active species generated during activation, for example of the strong acids, in the curable adhesive compound and indirectly also the physicochemical parameters influenced thereby, for example the pH, after activation exhibit a non-linear profile. Depending on the observed measured variable, at least one minimum or maximum is traversed before the measured variable approaches the initial level again with regard to most of the parameters on attainment of the maximum curing which can be achieved and thus the maximum bond strength which can be achieved.

Because the preference in WO 2020119898 A1, based on the previously known state of the art, is to indicate the immediate start of the activation, the color change of the dye used there must take place at a time at which the curable adhesive compound still almost corresponds to the initial state and the relevant parameter, the pH for example, is only slightly different. Conversely, however, this means that the reverse color change back to the original color inevitably takes place when the relevant parameter is again close to the initial value, but this is only achieved at the earliest when the maximum possible curing is reached. This indication of complete curing, for example after 24 h when using Sudan blue, is deliberately intended in WO 2020119898 A1.

However, the inventors have found that the state of maximum achievable curing as it is indicated in WO 2020119898 A1, for example, by a color change of Sudan Blue II after 24 h, especially in the light of a frequently non-linear increase in bond strength, with regard to the optimized time and cost efficiency, is for most manufacturing processes not the state that is absolutely necessary. In most cases, instead, reliable further processing is also possible even when the curing adhesive compound is still clearly remote from the state of maximum achievable bond strength. In many cases, this is surprisingly true even when the further processing is associated with noticeable mechanical loads on the component assembly.

Accordingly, the inventors propose that, in contrast to the teaching of WO 2020119898 A1, the curable adhesive compound should instead be formulated such that a change of color takes place at a time at which the adhesive compound has a medium curing state, which is beneficially adaptable by the skilled person to the specific requirements of the subsequent processing steps, i.e., for example, the expected mechanical load on the component assembly. This enables a much faster cycling in corresponding manufacturing processes, since the employed workers and/or sensors directed at the color change receive the visual information at exactly the optimized time that the component assembly produced is ready for further processing.

The objects stated above are thus achieved by the subject matter of the invention as defined in the claims. Preferred configurations according to the invention result from the dependent claims and the observations hereinafter.

Embodiments which are hereinafter designated as preferred are combined in particularly preferred embodiments with features of other embodiments designated as preferred. Very particularly preferred, therefore, are combinations of two or more of the embodiments designated below as particularly preferred. Also preferred are embodiments in which a feature of one embodiment that is designated in any degree as preferred is combined with one or more further features of other embodiments that are designated in any degree as preferred. Features of preferred adhesive tapes, uses and methods result from the features of preferred curable adhesive compounds.

Insofar as subsequently for an element, for example for the (co)polymers or the polymerizable epoxy compounds, both specific amounts or fractions of this element and preferential configurations of the element are disclosed, the disclosure is also in particular of the specific amounts or fractions of the preferentially configured elements. In addition, it is disclosed that with the corresponding specific total amounts or total fractions of the elements, at least a part of the elements can be preferentially configured and in particular also that preferentially configured elements within the specific total amounts or total fractions may in turn be present in the specific amounts or fractions.

The invention relates to a curable adhesive compound, comprising:
a) one or more (co)polymers,
b) one or more polymerizable epoxy compounds,
c) one or more cationic initiators, and
d) one or more pH color indicators with at least one pH-dependent color change,
wherein the mass ratio of the combined mass of the cationic initiators to the combined mass of the pH color indicators in the curable adhesive compound is 5:1 or more, and
wherein the curable adhesive compound has a composition such that a pH-dependent color change of the one or more pH color indicators takes place during the cationic curing of the curable adhesive compound at a time at which the bond strength of the curing adhesive compound is in the range from 20% to 80% of the maximum bond strength achievable by the cationic curing.

Curable adhesives are comprehensively known to the skilled person as described above from the prior art, where the individual components specified above are also known to the skilled person in isolation and are commercially available in different variations from numerous different suppliers, with preferred and exemplary representatives of the individual components being disclosed below.

These above-defined constituents are each used as “one or more” in accordance with the skilled understanding. The term “one or more” refers here, in the manner usual in the sector, to the chemical nature of the compounds in question and not to the amount of substance thereof. For example, the curable adhesive compound may comprise as polymerizable epoxy compound exclusively epoxycyclohexylmethyl 3′,4′-epoxycyclohexanecarboxylate, which would mean that the curable adhesive compound comprises a multiplicity of the corresponding molecules.

The curable adhesive compound of the invention is curable. Owing to the possibility for curing, the curable adhesive compound can act as a structural adhesive after curing. According to DIN EN 923:2016-03, structural adhesives are demonstrably suitable for the production of load-bearing constructions in which the adhesive bond can be stressed over long periods with a high percentage of the maximum breaking force without failure (according to the ASTM definition: “bonding agents used for transferring required loads between adherends exposed to service environments typical for the structure involved”). They are therefore adhesives for highly chemically and physically stressable bonds that contribute to the strengthening of the adhesive tapes in the cured state.

Central to the curable adhesive compound of the invention is that the curable adhesive compound has a composition such that a pH-dependent color change of the one or more pH color indicators takes place during the cationic curing of the curable adhesive compound at a time at which the bond strength of the curing adhesive compound is in the range from 20% to 80% of the maximum bond strength achievable by the cationic curing—this expresses that the curable adhesive compound is embodied or equipped accordingly.

In practice, the correlation between the time of the color change and the bond strength at this point in time shows only a very low dependence on the initiation conditions, even at low radiation power levels, so that these do not necessarily have to be specified in the estimation of the inventors. However, the skilled person readily understands that the above design of the curable adhesive compound should beneficially be attuned to a serious, practice-relevant activation. In other words, in the vast majority of cases the curable adhesive compound according to the invention will be a curable adhesive compound whose composition is such that after activation with a radiation dose of 1000 mJ/cm² or more, preferably 2000 mJ/cm² or more, a pH-dependent color change of the one or more pH color indicators takes place during the cationic curing of the curable adhesive compound at a time at which the bond strength of the curing adhesive compound is in the range from 20% to 80% of the maximum bond strength achievable by the cationic curing.

The inventors assume that, in case of doubt, the fine-tuning will take place with a predetermined radiation dose corresponding to the radiation dose specified by the corresponding manufacturer of the curable adhesive compounds for their subsequent use. In view of the observed low dependence on the initiation conditions, however, in case of doubt, a typical radiation dose may also simply be specified. In this case, then, the curable adhesive compound according to the invention is a curable adhesive compound whose composition is such that after activation with a radiation dose of 3000 mJ/cm², a pH-dependent color change of the one or more pH color indicators takes place during the cationic curing of the curable adhesive compound at a time at which the bond strength of the curing adhesive compound is in the range from 20% to 80% of the maximum bond strength achievable by the cationic curing.

The skilled person understands that the adhesive compound is, in other words, a curable adhesive compound which comprises the constituents described above and whose composition is such that a pH-dependent color change of the one or more pH color indicators takes place during the cationic curing of the curable adhesive compound at a time at which the bond strength of the curing adhesive compound is in the range from 20% to 80% of the maximum bond strength achievable by the cationic curing.

Again, in other words, the adhesive compound is a curable adhesive compound which comprises the constituents described above, the adhesive being curable by cationic curing in such a way that the adhesive compound shows a pH-dependent color change of the one or more pH color indicators if the curing adhesive compound has a bond strength that is in the range from 20% to 80% of the maximum bond strength achievable by the cationic curing.

Likewise in other words, the adhesive compound is a curable adhesive compound which comprises the constituents described above, where the adhesive compound on cationic curing at the time of a pH-dependent color change of the one or more pH color indicators exhibits a bond strength that is in the range from 20% to 80% of the maximum bond strength achievable by the cationic curing.

The skilled person in the field of chemistry, in particular in the field of adhesive technology, is in a position to set up the curable adhesive compound in the light of the teaching taught here by adapting the composition in the manner as defined above.

The skilled person understands that a pH-dependent color change which is effected by the pH color indicator must take place within the specified relative bond strength range, but also that not all pH-dependent color changes that the pH color indicator traverses in the course of curing must lie within the relative bond strength range. This is particularly because a pH color indicator with a changing point will regularly experience two color changes during curing, namely when the changing point is exceeded in each of the two possible directions, i.e., from high pH values to low pH values and vice versa, in most cases, according to the inventors' estimation, it will be the second color change that will indicate the achievement of the desired bond strength. This second color change is in practice in most cases the change from low to higher pH values. In most cases, therefore, the adhesive compound is a curable adhesive compound according to the invention wherein the curable adhesive compound has a composition such that the pH-dependent color change of the one or more pH color indicators is caused by an increase in the pH.

In accordance with the expert understanding, in particular the initial value of the pH in the non-activated curable adhesive compound, but also the temporal development of the pH, are critically dependent on the components used in the adhesive compound, for example the nature and concentration of the cationic initiators, so that it is difficult to generalize the selection of the pH color indicators by which the setting-up of the curable adhesive compound will take place critically in practice.

However, in the light of the above teaching, the skilled person can produce the curable adhesive compounds in the course of normal expert experiments and attune them to the respective requirements, and may beneficially proceed on the basis of the exemplary embodiments disclosed below.

In the light of the teaching of the present invention, the skilled person may proceed, for example, in such a way that they first produce a curable initial adhesive compound comprising:
aa1) one or more (co)polymers,
bb1) one or more polymerizable epoxy compounds, and
cc1) one or more cationic initiators,
which therefore still lacks the pH color indicators, but which with regard to the physicochemical properties, in particular after curing, is optimized to the respective requirements facing the skilled person.

Through tests, the skilled person, who in regard of the invention knows what they want to achieve, is able for this curable initial adhesive compound to determine the bond strength which is sufficient for the intended further processing of the component assembly.

It is particularly useful for the first rough attunement if the skilled person initially records only the time taken to achieve the desired bond strength, with which, for example, further processing without damage to the bonded assembly is possible. As a result of this, advantageously, at this point in time no quantification of the absolute values of the desired bond strength or the maximum achievable bond strength is necessary.

The skilled person can now identify, by various means, suitable pH color indicators which they need for the implementation of the invention. For example, the skilled person may, for example, introduce various pH color indicators available to them into the initial adhesive compound and experimentally test which of these pH color indicators show a color change in the vicinity of the time estimated by the skilled person, or ideally shortly after the estimated time. Alternatively, the skilled person may also determine the pH of the curing adhesive compound they assess as being optimally cured and select a suitable pH color indicator on the basis of tabulated values which, for pH color indicators, tabulate the respective changing points.

Starting from the system which combines the initial adhesive compound with the pH color indicator identified as suitable, the skilled person can then go into fine-tuning, where the skilled person can optimize the concentrations of the individual components of the curable adhesive compound further in the usual way in routine experiments. For example, in an iterative optimization process, the skilled person will in particular compensate for or take into account the addition of the pH color indicator, which can at least potentially change the properties of the initial adhesive compound, at least if it is to be used in larger quantities: in particular, some basic pH color indicators can also influence the pH and can influence the cationic activation, so that the adhesive compound system can be adapted accordingly in an expert manner step by step until its properties are sufficient for the intended application.

The skilled person can then determine the bond strength at the time of the color change and compare it with the maximum bond strength achievable by the cationic curing, to verify that it is within the interval to be set according to the invention. The maximum achievable bond strength is to be determined here readily for the skilled person as the bond strength which comes about as the resulting limit value within the scope of the measurement inaccuracy of the determination method after initiation of the cationic curing. Since the bond strength usually reaches substantially a plateau value in accordance with the expert understanding, and the skilled person based on their experience will usually be able to make a reasonable estimate of when the curing is substantially complete, time-dependent measurements of the bond strength can usually be dispensed with in practice. In many cases, it is instead sufficient to determine the bond strength after a time for which the skilled person is certain that the curing should be complete; the constancy of values can be further confirmed by subsequent safeguarding measurements after, for example, a few additional hours. A more precise determination, beyond this, of the maximum achievable bond strength is not necessary for the vast majority of cases anyway and may be most likely to be useful when the relative bond strength at the color change ought to be very close to the limit values of the range defined above.

The measured variable of the bond strength to be determined within the scope of the present invention is an established variable for the skilled person in the field of adhesive technology. In principle, this variable can be measured in different test setups and under different conditions. Since a relative bond strength is defined in the context of the present invention in relation to a final value, the skilled person may in principle employ any method for determining the bond strength, as long as they determine both values using the same method; this will, however, be a matter of course for the skilled person. In the context of the present invention, the bond strength is determined in doubt, especially if the relative bond strength is close to the limits of the defined range, in an industry-standard method in a dynamic tensile shear test according to DIN EN 1465:2009-07 at 23 °C and 50% relative humidity for a test speed of 1 mm/min.

According to the inventors' estimation, the color change should not take place too early, since below 20% of the maximum achievable bond strength it is unlikely that the component assemblies that can be produced accordingly will have sufficient strength in subsequent processing steps. If, on the other hand, the color change takes place only at more than 80% of the maximum achievable bond strength, the inventors estimate that the achievable advantages in the improved cycling will be too low. Thus, in the curable adhesive compounds of the invention, there is a conflict of objectives between sufficient bond strength and rapid further processing of the joined component assemblies. In this respect, the inventors propose that this conflict of objectives be advantageously resolved, especially at medium relative bond strengths. A curable adhesive compound according to the invention is preferred, against this background, wherein the curable adhesive compound has a composition such that a pH-dependent color change of the one or more pH color indicators takes place during the cationic curing of the curable adhesive compound at a time at which the bond strength of the curing adhesive compound is in the range from 25% to 75%, preferably in the range from 30% to 70%, more preferably in the range from 35% to 65% of the maximum bond strength achievable by the cationic curing.

In absolute values, in the estimation of the inventors, for most practice-relevant applications, a curable adhesive compound according to the invention is preferred wherein the curable adhesive compound has a composition such that a pH-dependent color change of the one or more pH color indicators takes place during the cationic curing of the curable adhesive compound at a time at which the bond strength of the curing adhesive compound is in the range from 1.5 to 4.5 MPa, preferably in the range from 2.0 to 4.0 MPa, more preferably in the range from 2.5 to 3.5 MPa, as measured according to DIN EN 1465:2009-07 at 23 °C and 50% relative humidity for a test speed of 1 mm/min.

The absolute value ranges specified above can be specified by the inventors on the basis of their comprehensive knowledge of the requirements which are made especially in the automotive industry sphere with regard to curable adhesive compounds. The skilled person understands in this respect that the invention is also related to a curable adhesive composition, comprising:
a) one or more (co)polymers,
b) one or more polymerizable epoxy compounds,
c) one or more cationic initiators, and
d) one or more pH color indicators with at least one pH-dependent color change,
wherein the mass ratio of the combined mass of the cationic initiators to the combined mass of the pH color indicators in the curable adhesive composition is 5:1 or more, and
wherein the curable adhesive composition has a composition such that a pH-dependent color change of the one or more pH color indicators takes place during the cationic curing of the curable adhesive composition at a time at which the bond strength of the curing adhesive composition is in the range from 1.5 to 4.5 MPa, preferably in the range from 2.0 to 4.0 MPa, more preferably in the range from 2.5 to 3.5 MPa, as measured according to DIN EN 1465:2009-07 at 23 °C and 50% relative humidity for a test speed of 1 mm/min.

In view of the typical maximum achievable bond strengths, in the vast majority of cases, the curable adhesive composition disclosed will be a curable adhesive compound according to the invention. In addition, the curable adhesive composition according to the estimation of the inventors is also extremely advantageous in itself, wherein the above statements regarding the advantages and the production and also the following statements regarding preferred curable adhesive compounds according to the invention each apply correspondingly, and wherein the disclosed curable adhesive compositions in particular can also be used in corresponding adhesive tapes, methods and uses.

The curable adhesive compounds according to the invention can advantageously also be provided in principle as liquid systems. For later use in the end application, however, it is advantageous for the handling properties if the curable adhesive compound has an intrinsic pressure-sensitive adhesiveness and can thus be classified as a pressure-sensitive adhesive. The pressure-sensitive adhesiveness allows reliable and secure application of the reactive adhesive tapes to the substrate before the curing of the curable adhesive compounds. Preferred accordingly is a curable adhesive compound of the invention wherein the curable adhesive compound is a pressure-sensitive adhesive compound. In the estimation of the inventors, it is expedient to adjust the combined mass fraction of the (co-)polymers in the curable adhesive compound to 25% or more, preferably 30% or more, more preferably 35% or more, for the implementation of the pressure-sensitive adhesiveness.

A pressure-sensitive adhesive compound, in accordance with the skilled understanding, is an adhesive compound which has pressure-sensitive adhesive properties, i.e., the property of making a permanent connection to an adhesion base even under relatively low contact pressure. Corresponding pressure-sensitive adhesive tapes are usually redetachable from the adhesion base after use, essentially free of residue, and are usually permanently self-adhesive even at room temperature, which means that they have a certain viscosity and touch-stickiness, so that they wet the surface of a substrate even with little contact pressure. The pressure-sensitive adhesiveness of a pressure-sensitive adhesive tape results from the fact that a pressure-sensitive adhesive is used as the adhesive compound. Without wanting to be bound by this theory, it is often assumed that a pressure-sensitive adhesive can be considered as an extremely high-viscosity fluid with an elastic component, which consequently has characteristic viscoelastic properties, which lead to the above-described permanent self-adhesiveness and pressure-sensitive adhesive capacity.

It is assumed that with corresponding pressure-sensitive adhesives, mechanical deformation results both in viscous flow processes and in the build-up of elastic restoring forces. The proportional viscous flow is used to achieve adhesion, while the proportional elastic restoring forces are particularly necessary for achieving cohesion. The relationships between rheology and pressure-sensitive adhesiveness are known in the prior art and are described, for example, in “Satas, Handbook of Pressure Sensitive Adhesive Technology”, Third Edition (1999), pages 153 to 203. The storage modulus (G′) and the loss modulus (G″), which can be determined by means of dynamic mechanical analysis (DMA), for example using a rheometer, as disclosed, for example, in WO 2015/189323, are usually used to characterize the extent of elastic and viscous components. In the context of the present invention, an adhesive is preferably understood as being pressure-sensitively adhesive and thus as a pressure-sensitive adhesive when at a temperature of 23 °C in the deformation frequency range from 10⁰ to 10¹ rad/sec, G′ and G″ are each at least in part in the range from 103 to 107 Pa.

The components contained in the curable adhesive compound according to the invention are explained in more detail below. In this respect, the inventors have succeeded in identifying particularly preferred embodiments and mass fractions for the individual components, with which high-performance curable adhesive compound according to the invention can be obtained. In a manner customary in the sector, the mass fractions are expressed as combined mass fractions of the one or more components, meaning that the mass fraction of the correspondingly embodied components taken together meets the corresponding criteria, with the reference system being in each case, unless otherwise specified, the mass of the curable adhesive compound.

The skilled person understands that the (co-)polymers usually play the role of the film-former, which becomes particularly important when, for example, pressure-sensitive adhesive compounds are to be obtained. In other words, the use of (co-)polymers customary in the field of adhesive technology thus involves a curable adhesive compound, with the one or more (co-)polymers being selected from the group consisting of film-forming (co-)polymers.

Preferred, in addition or alternatively, is a curable adhesive compound according to the invention wherein the one or more (co-)polymers are selected from the group consisting of poly(meth)acrylates, polyurethanes, polyvinyl acetals, such as polyvinyl butyral, polysiloxanes, synthetic rubbers, polyesters, phenoxy polymers, polyvinyl alcohols, polyvinyl alcohol copolymers, and alkene-vinyl acetate copolymers, preferably selected from the group consisting of poly(meth)acrylates, phenoxy polymers, polyvinyl alcohols, polyvinyl alcohol copolymers, polyvinyl acetals, such as polyvinyl butyral, and ethylene-vinyl acetate copolymers (EVA or EVAC, poly(ethylene-co-vinyl acetate)), more particularly selected from the group consisting of poly(meth)acrylates, phenoxy polymers and ethylene-vinyl acetate copolymers.

In addition or alternatively, block copolymers, e.g., (meth)acrylate block copolymers, can also be used as (co-)polymers. Corresponding examples are disclosed in US 2011003947 A1, US 20080200589 A1, US 2007078236 A1, US 2012196952 A1, US 2016032157 A1, US 2008146747 A1 and US 2016230054 A1, for example.

The number-average molar masses Mₙ of the (co-)polymers are preferably in a range from 50 000 to 10 000 000 g/mol, more preferably in a range from 100 000 to 5 000 000 g/mol, very preferably in a range from 150 000 to 2 000 000 g/mol. The data for the number-average molar mass Mₙ refers to the determination by gel permeation chromatography (GPC). The determination is carried out using a clear filtered 100 μl sample (sample concentration 4 g/I). The eluent employed is THF comprising 0.1 vol % trifluoroacetic acid. The measurement is conducted at 25 °C The pre-column used is a column type PSS-SDV, 5 μm, 10³ Å, 8.0 mm*50 mm (values here and below in the sequence: type, particle size, porosity, internal diameter*length; 1 Å=10⁻¹⁰ m). For the separation, a combination is used of the columns of the type PSS-SDV, 5 μm, 10³ Å and also 10⁵ Å and 10⁶ Å, in each case 8.0 mm*300 mm (columns from Polymer Standards Service; detection by means of differential refractometer Shodex R171). The flow rate is 1.0 ml per minute. The calibration is carried out for polyacrylates against PMMA standards (polymethyl methacrylate calibration) and otherwise (resins, elastomers) against PS standards (polystyrene calibration).

Independently of the specific selection of the (co-)polymers, a curable adhesive compound according to the invention is preferred wherein the combined mass fraction of the (co-)polymers in the curable adhesive compound is in the range from 1% to 70%, preferably in the range from 2% to 60%, more preferably in the range from 5% to 50%, very preferably in the range from 10% to 40%, based on the mass of the curable adhesive compound. As explained above, it is expedient, for obtaining a pressure-sensitive adhesive curable adhesive compound, to adjust the combined mass fraction of the (co-)polymers in the curable adhesive compound to 25% or more, preferably 30% or more, more preferably 35% or more, very preferably in a range from 25% to 40%.

In addition to the (co-)polymers, the curable adhesive compound according to the invention also comprises at least one polymerizable epoxy compound and optionally further polymerizable compounds. These compounds together form the part of the curable adhesive compound often referred to by the skilled person as reactive resin.

The expression “polymerizable” refers in accordance with the expert understanding to the ability of these compounds, where appropriate after suitable activation, to enter into a polymerization reaction. In the case of the polymerizable epoxy compounds, the polymerizability is made possible for example by the epoxy groups.

In accordance with the skilled understanding, epoxy compounds are compounds that carry at least one oxirane group. They may be aromatic or aliphatic, especially cycloaliphatic, in nature. Polymerizable epoxy compounds may include not only monomeric but also oligomeric and/or polymeric epoxy compounds. Polymerizable epoxy compounds often have on average at least two epoxy groups per molecule, preferably more than two epoxy groups per molecule. Preferred accordingly is a curable adhesive compound according to the invention wherein the one or more polymerizable epoxy compounds are selected from the group consisting of epoxy compounds having two or more epoxy groups, preferably two epoxy groups.

The oligomeric and/or polymeric epoxy compounds comprise mostly linear polymers having terminal epoxy groups (e.g., a diglycidyl ether of a polyoxyalkylene glycol), polymers with framework oxirane units (e.g., polybutadiene polyepoxide) and polymers having epoxy side groups (e.g., a glycidyl methacrylate polymer or copolymer). The molecular weight of such epoxy compounds can vary from 58 to about 100 000 g/mol or more, with the molecular weight being an important control variable for adjusting the dynamic viscosity. Illustrative polymerizable epoxy compounds include epoxycyclohexanecarboxylates, such as, for example, 4-epoxyclohexylmethyl 3,4-epoxycyclohexanecarboxylate, 3,4-epoxy-2-methylcyclohexylmethyl 3,4-epoxy-2-methylcyclohexanecarboxylate, and bis(3,4-epoxy-6-methylcyclohexylmethyl) adipate. Further examples of polymerizable epoxy compounds are disclosed in, for example, U.S. Pat. No. 3,117,099 A. Further polymerizable epoxy compounds which are particularly useful in the application of this invention include glycidyl ether monomers, as disclosed for example in U.S. Pat. No. 3,018,262. Examples are the glycidyl ethers of polyhydric phenols obtained by reacting a polyhydric phenol with an excess of chlorohydrin, such as epichlorohydrin (e.g. the diglycidyl ether of 2,2-bis(2,3-epoxypropoxyphenol)propane). In particular, diglycidyl ethers of bisphenols, such as bisphenol A (4,4′-(propane-2,2-diyl)diphenol) and bisphenol F (bis(4-hydroxyphenyl)methane). Such reaction products are available commercially in different molecular weights and physical states (for example, so-called type 1 to type 10 BADGE resins). Typical examples of liquid bisphenol A diglycidyl ethers are Epikote 828, D.E.R.331 and Epon 828. Typical solid BADGE resins are Araldite GT6071, GT7072, Epon 1001 and D.E.R. 662. Other reaction products of phenols with epichlorohydrin are the phenol and cresol novolac resins such as the Epiclon grades or Araldite EPN and ECN grades (e.g. ECN1273).

Preferred, according to the estimation of the inventors, is a curable adhesive compound according to the invention wherein the one or more polymerizable epoxy compounds are selected from the group consisting of epoxy compounds having at least one cycloaliphatic group, in particular a cyclohexyl group or dicyclopentadienyl group. Preferred, in addition or alternatively, is a curable adhesive compound according to the invention wherein the one or more polymerizable epoxy compounds are selected from the group consisting of bisphenol A diglycidyl ethers and bisphenol F diglycidyl ethers, preferably bisphenol A diglycidyl ethers.

In the estimation of the inventors, particularly advantageous curable adhesive compounds can be obtained if two or more different polymerizable epoxy compounds are used, especially if they differ in terms of their physical state at room temperature. A curable adhesive compound according to the invention is preferred wherein the curable adhesive compound comprises one or more polymerizable epoxy compounds selected from the group of epoxy compounds which at 25 °C are solids or highly viscous substances with a dynamic viscosity of 50 Pa s or more, preferably 100 Pa s or more, more preferably 150 Pa s or more, and/or wherein the curable adhesive compound comprises one or more polymerizable epoxy compounds selected from the group of epoxy compounds which at 25 °C are a fluid having a dynamic viscosity of 40 Pa s or less, preferably 20 Pa s or less, very preferably 10 Pa s or less. In the context of the present invention, the dynamic viscosity is determined according to DIN 53019-1 from 2008; at 25 °C, with a shear rate of 1 s⁻¹.

Independently of the specific selection of the polymerizable epoxy compounds, a curable adhesive compound according to the invention is preferred wherein the combined mass fraction of the polymerizable epoxy compounds in the curable adhesive compound is in the range from 35% to 95%, preferably in the range from 40% to 90%, more preferably in the range from 45% to 85%, very preferably in the range from 50% to 80%, based on the mass of the curable adhesive compound.

The curable adhesive compounds according to the invention comprise at least one cationic initiator. Corresponding cationic initiators are known to the skilled person on the basis of their general knowledge and are often used in particular in the field of epoxy-based reactive adhesive compounds. The skilled person matches the catalyst system used for curing essentially to the application requirements and the polymerizable epoxy compounds used.

With regard to the later handling properties, it is particularly advantageous according to the inventors' assessment to use radiation-crosslinking and/or thermally crosslinking systems, wherein in particular the radiation activation provides great handling advantages. Preferred here is a curable adhesive compound according to the invention wherein the one or more cationic initiators are selected from the group consisting of radiation-activated initiators and thermally activated initiators, preferably selected from the group consisting of radiation-activated initiators, or wherein the curable adhesive compound is a radiation-curing and/or thermally curing, preferably radiation-curing, adhesive compound.

For example, latent, thermally activatable cationic initiators (TAGs; “thermal acid generators”) are preferred as thermally activated cationic initiators. Suitable TAGs are known to the skilled person and available commercially from numerous providers. Preferred TAGs are those comprising a cation selected from the group consisting of 4-substituted benzylanilinium, 4-substituted benzylpyridinium, 4-substituted benzylphosphonium, S-substituted diphenylsulfonium and substituted aryl-benzylsulfonium, preferably selected from the group consisting of 4-substituted benzylanilinium. The TAG can in principle contain any anion, with weakly coordinating anions such as tetrafluoroborate (BF₄⁻), hexafluorophosphate (PF₆⁻), hexafluoroantimonate (SbF₆⁻), tetrakis(pentafluorophenyl)borate (B(CeF₅)₄⁻) and trifluoromethylsulfonate (F₃CSO₃⁻) being preferred. Particularly preferred here are trifluoromethylsulfonate (F₃CSO₃⁻) and hexafluoroantimonate (SbF₆⁻).

Advantageous combinations of a TAG composed of cation and anion are those for which the resulting initiator has an activation temperature in the range from 50 °C to 150 °C, wherein the skilled person preferably adjusts the activation energy to the respective application requirements, in particular, a range from 80 °C to 120 °C is preferred in many cases in order to be able to carry out the polymerization at a comparatively moderate activation temperature and still allow a clearly delimited initiation. The activation temperature of reactive or chemically activatable adhesive compounds in general and of the TAGs used is determined calorimetrically by differential scanning calorimetry (DSC) according to DIN EN ISO 11357-3:2013-04. For this, approximately 20 mg of the sample are weighed out into an aluminum crucible and introduced into the measuring device (instrument: DSC 204 F1, from Netzsch). Two heating curves with a heating rate of 10 K/min are then recorded. The specimens are analyzed in Al crucibles with a perforated lid and nitrogen atmosphere. A chemical reaction, such as the activation of the TAG, can be seen as an exothermic peak in the thermogram. The onset temperature is recorded as the activation temperature. This is determined for a peak as the intersection point of the virtual interpolated baseline and the tangent applied at the inflection point of the start of the peak (according to DIN EN ISO 11357-1:2010-03). Integration of the curing peak gives the reaction enthalpy in J/g.

Sulfonium, iodonium and metallocene based systems in particular can be used as initiators for a cationic, radiation-based—i.e., often UV-induced—curing of epoxy compounds. For examples of sulfonium based cations, refer to the observations in U.S. Pat. No. 6,908,722 B1. Examples of anions which serve as counterions for the abovementioned cations include tetrafluoroborate, tetraphenylborate, hexafluorophosphate, perchlorate, tetrachloroferrate, hexafluoroarsenate, hexafluoroantimonate, pentafluorohydroxyantimonate, hexachloroantimonate, tetrakispentafluorophenylborate, tetrakis(pentafluoromethylphenyl)borate, bi(trifluoromethylsulfonyl)amide and tris(trifluoromethylsulfonyl)methide. Other conceivable anions particularly for iodonium-based initiators are additionally chloride, bromide or iodide, but preference is given to initiators that are essentially free of chlorine and bromine. A powerful example of such a system is, for example, triphenylsulfonium hexafluoroantimonate. Further suitable initiators are disclosed for example in U.S. Pat. Nos. 3,729,313 A, 3,741,769 A, 4,250,053 A, 4,394,403 A, 4,231,951 A, 4,256,828 A, 4,058,401 A, 4,138,255 A and US 2010/063221 A1.

Specific examples of employable sulfonium salts are triarylsulfonium salts in particular, examples being triphenylsulfonium hexafluoroarsenate, triphenylsulfonium hexafluoroborate, triphenylsulfonium tetrafluoroborate, triphenylsulfonium tetrakis(pentafluorobenzyl)borate, methyldiphenylsulfonium tetrafluoroborate, methyldiphenylsulfonium tetrakis(pentafluorobenzyl) borate, dimethylphenylsulfonium hexafluorophosphate, triphenylsulfonium hexafluorophosphate, triphenylsulfonium hexafluoroantimonate, diphenylnaphthylsulfonium hexafluoroarsenate, tritolylsulfonium hexafluorophosphate, anisyldiphenylsulfonium hexafluoroantimonate, 4-butoxyphenyldiphenylsulfonium tetrafluoroborate, 4-chlorophenyldiphenylsulfonium hexafluoroantimonate, tris(4-phenoxyphenyl)sulfonium hexafluorophosphate, di(4-ethoxyphenyl)methylsulfonium hexafluoroarsenate, 4-acetylphenyldiphenylsulfonium tetrafluoroborate, 4-acetylphenyldiphenylsulfonium tetrakis(pentafluorobenzyl)borate, tris(4-thiomethoxyphenyl)sulfonium hexafluorophosphate, di(methoxysulfonylphenyl)methylsulfonium hexafluoroantimonate, di(methoxynaphthyl)methylsulfonium tetrafluoroborate, di(methoxynaphthyl)methylsulfonium tetrakis(pentafluorobenzyl)borate, di(carbomethoxyphenyl)methylsulfonium hexafluorophosphate, (4-octyloxyphenyl)diphenylsulfonium tetrakis(3,5-bis(trifluoromethyl)phenyl)borate, tris[4-(4-acetylphenyl)thiophenyl]sulfonium tetrakis(pentafluorophenyl)borate, tris(dodecylphenyl)sulfonium tetrakis(3,5-bistrifluoromethylphenyl)borate, 4-acetamidophenyldiphenylsulfonium tetrafluoroborate, 4-acetamidophenyldiphenylsulfonium tetrakis(pentafluorobenzyl)borate, dimethylnaphthylsulfonium hexafluorophosphate, trifluoromethyldiphenylsulfonium tetrafluoroborate, trifluoromethyldiphenylsulfonium tetrakis(pentafluorobenzyl)borate, phenylmethylbenzylsulfonium hexafluorophosphate, 5-methylthianthrenium hexafluorophosphate, 10-phenyl-9,9-dimethylthioxanthenium hexafluorophosphate, 10-phenyl-9-oxothioxanthenium tetrafluoroborate, 10-phenyl-9-oxothioxanthenium tetrakis(pentafluorobenzyl)borate, 5-methyl-10-oxothianthrenium tetrafluoroborate, 5-methyl-10-oxothianthrenium tetrakis(pentafluorobenzyl)borate and 5-methyl-10,10-dioxothianthrenium hexafluorophosphate.

Specific examples of employable iodonium salts are diphenyliodonium tetrafluoroborate, di(4-methylphenyl)iodonium tetrafluoroborate, phenyl-4-methylphenyliodonium tetrafluoroborate, di(4-chlorophenyl)iodonium hexafluorophosphate, dinaphthyliodonium tetrafluoroborate, di(4-trifluoromethylphenyl)iodonium tetrafluoroborate, diphenyliodonium hexafluorophosphate, di(4-methylphenyl)iodonium hexafluorophosphate, diphenyliodonium hexafluoroarsenate, di(4-phenoxyphenyl)iodonium tetrafluoroborate, phenyl-2-thienyliodonium hexafluorophosphate, 3,5-dimethylpyrazol-4-ylphenyliodonium hexafluorophosphate, diphenyliodonium hexafluoroantimonate, 2,2′-diphenyliodonium tetrafluoroborate, di(2,4-dichlorophenyl)iodonium hexafluorophosphate, di(4-bromophenyl)iodonium hexafluorophosphate, di(4-methoxyphenyl)iodonium hexafluorophosphate, di(3-carboxyphenyl)iodonium hexafluorophosphate, di(3-methoxycarbonylphenyl)iodonium hexafluorophosphate, di(3-methoxysulfonylphenyl)iodonium hexafluorophosphate, di(4-acetamidophenyl)iodonium hexafluorophosphate, di(2-benzothienyl)iodonium hexafluorophosphate, diaryliodonium tristrifluoromethylsulfonylmethide such as diphenyliodonium hexafluoroantimonate, diaryliodonium tetrakis(pentafluorophenyl)borate such as diphenyliodonium tetrakis-(pentafluorophenyl)borate, [4-(2-hydroxy-n-tetradesiloxy)phenyl]phenyliodonium hexafluoroantimonate, [4-(2-hydroxy-n-tetradesiloxy)phenyl]phenyliodonium trifluorosulfonate, [4-(2-hydroxy-n-tetradesiloxy)phenyl]phenyliodonium hexafluorophosphate, [4-(2-hydroxy-n-tetradesiloxy)phenyl]phenyliodonium tetrakis(pentafluorophenyl)borate, bis(4-tert-butylphenyl)iodonium hexafluoroantimonate, bis(4-tert-butylphenyl)iodonium hexafluorophosphate, bis(4-tert-butylphenyl)iodonium trifluorosulfonate, bis(4-tert-butylphenyl)iodonium tetrafluoroborate, bis(dodecylphenyl)iodonium hexafluoroantimonate, bis(dodecylphenyl)iodonium tetrafluoroborate, bis(dodecylphenyl)iodonium hexafluorophosphate, bis(dodecylphenyl)iodonium trifluoromethylsulfonate, di(dodecylphenyl)iodonium hexafluoroantimonate, di(dodecylphenyl)iodonium triflate, diphenyliodonium bisulfate, 4,4′-dichlorodiphenyliodonium bisulfate, 4,4′-dibromodiphenyliodonium bisulfate, 3,3′-dinitrodiphenyliodonium bisulfate, 4,4′-dimethyldiphenyliodonium bisulfate, 4,4′-bissuccinimidodiphenyliodonium bisulfate, 3-nitrodiphenyliodonium bisulfate, 4,4′-dimethoxydiphenyliodonium bisulfate, bis(dodecylphenyl)iodonium tetrakis(pentafluorophenyl)borate, (4-octyloxyphenyl)phenyliodonium tetrakis(3,5-bistrifluoromethylphenyl)borate and (tolylcumyl)iodonium tetrakis(pentafluorophenyl)borate, and ferrocenium salts (see for example EP 0 542 716 B1) such as rq5-(2,4-cyclopentadien-1-yl)[(1,2,3,4,5,6,9)(1-methylethyl)benzene]iron.

Photoinitiators are typically used individually or as a combination of two or more photoinitiators. When using photoinitiators, combinations with so-called sensitizers for the adaptation of the activation wavelength of the photoinitiation system to the selected emission spectrum are very helpful, in this regard, refer to the literature known to the skilled person, such as “Industrial Photoinitiators: A Technical Guide” 2010 by A. W. Green. Typically, in these cases, the mass fraction of photoinitiators in the curable adhesive compound is not more than 4% but at least 0.1%, and is preferably in the range from 0.5% to 2%. The mass fraction of sensitizers is usually not more than 3% and is preferably in the range from 0.5% to 2%.

Largely independently of the selection of the specific cationic initiator, a curable adhesive compound according to the invention is preferred wherein the combined mass fraction of the cationic initiators in the curable adhesive compound is in the range from 0.1% to 7%, preferably in the range from 0.3% to 5%, more preferably in the range from 0.5% to 4%, based on the mass of the curable adhesive compound.

The concept of pH color indicators is already familiar to the skilled person from education and the relationships for the color change of pH color indicators as a function of the pH are comprehensively understood. In accordance with the skilled understanding, the expression “color change” here means that there is a change in the absorption characteristics of the pH color indicators for electromagnetic radiation of a wavelength in the range of visible light, i.e., in the range from 380 to 780 nm, and so for an adhesive compound admixed with the pH color indicator there is an altered transmission or remission as a result of the color change.

Although it is conceivable in principle for the color indicator used to comprise pH color indicators with several pH-dependent color changes, such as thymol blue, it is in the inventors' estimation advantageous in most cases to employ pH color indicators with only one color change, in order to design the curable adhesive compound as clearly and precisely as possible. Preferred accordingly is a curable adhesive compound according to the invention wherein the one or more pH color indicators have exactly one pH-dependent color change.

The inventors have succeeded in identifying pH color indicators with which the above-identified relative bond strengths can be set particularly reliably in most curable adhesive compounds. According to the inventors' estimation, indeed, the pH of the changing point should be sufficiently low for the color to change only when the pH of the curable adhesive compound has already noticeably decreased because of the cationic curing and accordingly an advanced curing has been achieved. For substantially all embodiments there is therefore especial preference given, indeed, to a curable adhesive compound according to the invention wherein the one or more pH color indicators exhibit a pH-dependent color change, preferably the pH-technically highest color change in the case of two or more changing points, at a pH of 4 or less, preferably 3 or less, more preferably 2.5 or less.

Particularly preferred, based on the experiments of the inventors, in addition or alternatively, is a curable adhesive compound according to the invention wherein the one or more pH color indicators are selected from the group consisting of cresol red (CAS: 1733-12-6), methyl violet (CAS: 8004-87-3), crystal violet (CAS: 548-62-9), ethyl violet (CAS: 2390-59-2), malachite green (acetate—CAS: 1272-40-6; hydrochloride—CAS: 569-64-2; oxalate—CAS: 2437-29-8), methyl green (CAS: 7114-03-6), ethyl green (CAS: 14855-76-6), 2-(p-dimethylaminophenylazo)pyridine (CAS: 13103-75-8), metanil yellow (CAS: 587-98-4), 4-phenylazodiphenylamine (CAS: 101-75-7), thymol blue (CAS: 62625-21-2), metacresol purple (CAS: 2303-01-7), 4-[(4-anilinophenyl)azo]benzenesulfonic acid sodium salt (CAS: 554-73-4), 4-o-tolylazo-o-toluidine (CAS: 97-56-3), 2,2′,2″,4,4′-pentamethoxytriphenylmethanol (CAS: 80202-77-3), quinaldine red (CAS: 117-92-0), erythrosine disodium salt (CAS: 16423-68-0), 4,4′-bis(2-amino-1-naphthylazo)-2,2′-stilbenedisulfonic acid (CAS: 5437-12-7) and methyl yellow (CAS: 60-11-7), preferably selected from the group consisting of cresol red, methyl violet, crystal violet, ethyl violet, malachite green, methyl green, ethyl green, 2-(p-dimethylaminophenylazo)pyridine, metanil yellow, 4-phenylazodiphenylamine, thymol blue, metacresol purple, 4-[(4-anilinophenyl)azo]benzenesulfonic acid sodium salt, 4-o-tolylazo-o-toluidine and 2,2′,2″,4,4′-pentamethoxytriphenylmethanol.

The inventors have found that it is advantageous, in particular with regard to the targeted adjustment of the color change to the desired relative bond strength, but also with regard to the ranges of relative bond strength that are accessible via the pH color indicator, not to use azo dyes as a pH color indicator and instead to configure the curable adhesive compound as free of azo dyes as possible or with at least only a small fraction of azo dye. Preferred accordingly is a curable adhesive compound according to the invention wherein the one or more pH color indicators are selected from the group consisting of azo-bridge-free pH color indicators. Preferred is a curable adhesive compound according to the invention wherein the combined mass fraction of azo dyes in the curable adhesive compound is 0.005% or less, preferably 0.0001% or less, based on the mass of the curable adhesive compound. The inventors have found that it is advantageous, in particular with regard to the targeted adjustment of the color change to the desired relative bond strength, but also with regard to the ranges of relative bond strength that are accessible via the pH color indicator, not to use Sudan blue II, which is an anthraquinone dye from the group of Sudan dyes, and instead to configure the curable adhesive compound as free of Sudan blue as possible. Preferred accordingly is a curable adhesive compound according to the invention wherein the curable adhesive compound is substantially free of Sudan blue II, with the mass fraction of Sudan blue II in the curable adhesive compound being preferably 0.0001% or less, based on the mass of the curable adhesive compound.

From the finding that Sudan blue II as an anthraquinone dye from the group of Sudan dyes is less preferred for the curable adhesive compound according to the invention, the inventors conclude that this finding can presumably at least partly be transposed to other anthraquinone dyes and/or other Sudan dyes as well. There is therefore an inclination to prefer a curable adhesive compound according to the invention wherein the combined mass fraction of Sudan dyes in the curable adhesive compound is 0.005% or less, preferably 0.0001% or less, based on the mass of the curable adhesive compound. There is therefore an inclination, additionally or alternatively, to prefer a curable adhesive compound according to the invention wherein the combined mass fraction of anthraquinone dyes in the curable adhesive compound is 0.005% or less, preferably 0.0001% or less, based on the mass of the curable adhesive compound.

Largely independently of the selection of the specific pH color indicator, a curable adhesive compound according to the invention is preferred wherein the combined mass fraction of the pH color indicators in the curable adhesive compound is in the range from 0.01% to 0.4%, preferably in the range from 0.015% to 0.3%, based on the mass of the curable adhesive compound. Preferred also, in addition or alternatively, is a curable adhesive compound according to the invention wherein the combined mass fraction of the pH color indicators in the curable adhesive compound is 0.25% or less, preferably 0.2% or less, based on the mass of the curable adhesive compound, and/or wherein the combined mass fraction of the pH color indicators in the curable adhesive compound is 0.1% or more, preferably 0.15% or more, based on the mass of the curable adhesive compound.

Although the mass fractions of the cationic initiators and the pH color indicators can be chosen by the skilled person as explained above largely independently of the chemical nature of the respective components, the inventors have recognized that there is a certain correlation between the mass fractions of the components relative to each other. In practice, the fine-tuning of the curable adhesive compounds according to the invention will often be carried out, according to the inventors' estimation, via adaptation of the mass ratio of these two components. In this respect, the inventors have recognized that larger fractions of pH color indicators can in some cases interfere with the cationic curing, so that the curing process does not take place or only takes place incompletely. The inventors have recognized that this problem can be solved by increasing the relative mass fraction of cationic initiator.

The advantageous and reliable curability is ensured in the case of curable adhesive compounds according to the invention in that the mass ratio of the combined mass of the cationic initiators to the combined mass of the pH color indicators in the curable adhesive compound is 5:1 or more.

Based on their own experiments, the inventors have succeeded accordingly in identifying particularly advantageous mass ratios for the two components. Preferred, indeed, is a curable adhesive compound according to the invention wherein the mass ratio of the combined mass of the cationic initiators to the combined mass of the pH color indicators in the curable adhesive compound is 6:1 or more, preferably 8:1 or more, more preferably 10:1 or more. Preferred, in addition or alternatively, is a curable adhesive compound according to the invention wherein the mass ratio of the combined mass of the cationic initiators to the combined mass of the pH color indicators in the curable adhesive compound is in the range from 5:1 to 30:1, preferably in the range from 5:1 to 20:1.

It can be seen as an advantage of the curable adhesive compounds according to the invention that they are very flexible with regard to the presence of further components, and so it becomes advantageously possible to adapt the physicochemical properties particularly specifically to the respective requirements of the applications. Preferred, for example, is a curable adhesive compound according to the invention wherein the curable adhesive compound comprises one or more polyols, preferably in a combined mass fraction in the range from 0.5% to 15%, more preferably in the range from 1% to 10%. Preferred also, in addition or alternatively, is a curable adhesive compound according to the invention wherein the curable adhesive compound comprises one or more further additives, preferably in a combined mass fraction in the range from 0.1% to 50%, more preferably in the range from 0.2% to 40%, based on the mass of the curable adhesive compound, and/or wherein the one or more further additives are preferably selected from the group consisting of tackifier resins, aging inhibitors, light stabilizers, UV absorbers, rheological additives and additives for increasing the opacity.

In specific applications, an opacity (“haze”) may be desired for the curable adhesive compound according to the invention or the adhesive tape comprising the curable adhesive compounds according to the invention. Such specific applications are, for example, adhesive tapes for the electrical insulation of an object, such as battery cells. Here, a certain opacity is desirable to conceal visual defects, such as scratches. Preferred accordingly is the curable adhesive compound according to the invention which further comprises one or more additives for increasing the opacity. Having proven particularly advantageous with regard to curability of the adhesive compound, color strength and opacity are combinations of a combined mass fraction of a maximum of 0.3% of pH color indicator and with a combined mass fraction of a maximum of 5% of one or more additives for increasing the opacity, based on the mass of the curable adhesive compound. Especially preferred are combined mass fractions in the range from 0.1% to 0.25% of pH color indicator and combined mass fractions in the range from 0.1% to 0.3% of titanium dioxide.

A special case of the further components which are used to adjust the properties of adhesive compounds are insoluble fillers, which can be added to the curable adhesive compound in order to obtain a filled curable adhesive compound. These are particulate fillers with an average particle diameter (D50) of 5 μm or more, preferably 10 μm or more, especially preferably 20 μm or more, which are not soluble in the curable adhesive compound and are therefore present therein as a dispersion, and also macroscopic fillers such as fibres, for example. Preferably, the insoluble fillers are selected from the group consisting of particulate fillers. Particularly preferably, the insoluble fillers are selected from the group consisting of expandable hollow polymer spheres, non-expandable hollow polymer spheres, solid polymer spheres, hollow glass spheres, solid glass spheres, hollow ceramic spheres, solid ceramic spheres and/or solid carbon spheres. However, suitable insoluble fillers also include fibers, laid scrims, platelets and rodlets composed of materials insoluble in the curable adhesive compound. Owing to their in some cases already macroscopic dimensions and the lack of solubility, these essentially have no influence on the above-disclosed relationships of the compositional chemistry of the curable adhesive compounds, but rather are present in heterogeneous mixture with the curable adhesive compound. Accordingly, these insoluble fillers are not attributed to the curable adhesive compound within the scope of the present invention and are accordingly not taken into account in the calculation of mass fractions relative to the mass of the curable adhesive compound. The present invention instead defines that the addition of insoluble fillers to a curable adhesive compound of the invention results in a filled curable adhesive compound, i.e., a filled curable adhesive compound comprising:
i) a curable adhesive compound of the invention, preferably as disclosed above as being preferred, and
ii) one or more insoluble fillers.

Particularly preferably, the combined mass fraction of the insoluble fillers here is in the range from 1% to 50%, preferably in the range from 2% to 40%, particularly preferably in the range from 5% to 30%, based on the mass of the filled curable adhesive compound.

Curable adhesive compounds of the invention can be used for example directly as adhesive compounds, and depending on the application method they can be provided in particular in the form of tapes. The invention thus also relates to an adhesive tape, in particular a reactive adhesive tape, comprising as adhesive layer a curable adhesive compound of the invention, wherein the adhesive tape preferably comprises a carrier layer.

With a view to very favorable handling properties, particularly advantageous results are regularly achieved when curable adhesive compounds according to the invention are used as an adhesive layer of a single- or double-sided adhesive tape which also comprises a carrier layer, or when the adhesive layer is arranged on a release layer, for example a liner, from which the adhesive layer can be easily detached.

The term adhesive tape is clear to the skilled person in the field of adhesive technology. In the context of the present invention, the expression “tape” refers to all thin, flat structures, i.e. structures with a predominant extent in two dimensions, more particularly films, film portions and labels, preferably tapes with extended length and limited width, and corresponding tape portions.

The carrier layer usually refers to the layer of such a multilayer adhesive tape that significantly determines the mechanical and physical properties of the adhesive tape, such as the tear resistance, stretchability, insulation capacity or restoring capacity. Common materials for the carrier layer are, for example, woven fabrics, laid scrims and polymeric films, for example PET films and polyolefin films. However, the carrier layer can also be pressure-sensitively adhesive itself. The adhesive tape of the invention may in a preferred embodiment be a double-sided adhesive tape whose carrier layer is provided on both sides with a curable adhesive compound of the invention.

The carrier layer may also have electrically insulating properties, so that the corresponding adhesive tape according to the invention has an electrically insulating property and can be used for the electrical insulation of an object. For this purpose, use may be made of insulating carrier films with a volume resistivity of >10¹⁵ Ωcm, preferably >10¹⁶ Ωcm, further preferably >10¹⁷ Ωcm, determined according to DIN EN 62631-3-1 (VDE 0307-3-1): 2017 January. The adhesive tape according to the invention may therefore in one preferred embodiment be a double-sided adhesive tape whose insulating carrier film is provided on both sides with a curable adhesive compound according to the invention. In another preferred variant, the adhesive tape according to the invention is a single-sided adhesive tape whose electrically insulating carrier film is provided on one side with a curable adhesive compound according to the invention. Such single-sided adhesive tapes are outstandingly suitable for wrapping battery cells in hybrid vehicles and pure electric vehicles.

The insulating carrier film preferably comprises one or more materials selected from the group consisting of polyimide, polybenzimidazole, polyamideimide, polyetherimide, polyacetal, polyphenylene sulfide, polyetheretherketone, polytetrafluoroethylene, polyamide 6, ultrahigh molecular weight polyethylene, polypropylene, vinyl chloride resin, polystyrene, polyethylene terephthalate, acrylonitrile-butadiene-styrene, polycarbonate, polyvinyl chloride, ethylene-vinyl acetate copolymer and polyester, further preferably from the group consisting of polypropylene, polyethylene terephthalate, polycarbonate and polyvinyl chloride, further preferably from the group consisting of polypropylene and polyethylene terephthalate.

There are basically no special restrictions regarding the thickness of the carrier. Preferably, the carrier has a thickness in the range from 20 μm to 100 μm, further preferably in the 30 μm to 90 μm range, further preferably in the range from 40 μm to 75 μm.

In adhesive tapes according to the invention, the adhesive layers can be lined with a so-called release liner to allow trouble-free unwinding and to protect the pressure-sensitive adhesive against contamination. Such release liners usually consist of a one- or two-sidedly siliconized polymeric film (e.g. PET or PP) or a siliconized paper carrier.

In the light of the observations above, the invention also relates to a method for connecting two or more components before further processing steps, with which advantageous cycling and excellent time and cost efficiency can be realized. The method according to the invention comprises the method steps of:
w) producing or providing an adhesive tape according to the invention;
x) connecting two or more components with the adhesive tape and initiating the cationic curing of the curable adhesive compound by activating the one or more cationic initiators, to give a component assembly,
y) curing the curable adhesive compound until the color change of the one or more pH color indicators, to give a component assembly ready for further processing with an as yet incompletely cured curable adhesive compound, and
z) carrying out one or more further processing steps on the component assembly ready for further processing.

The skilled person understands that the further processing steps can be all typical processing steps, as they may occur, for example, in a typical production line, for example in automotive production, wherein the further processing steps are, in particular, further processing steps in which the generated connection of the components in the component assembly experiences a mechanical load, the mechanical load beneficially being lower than the bond strength at the time of the color change. In this method, a pH-dependent color change of the one or more pH color indicators thus takes place during the cationic curing of the curable adhesive compound preferably at a time at which the bond strength of the curing adhesive compound reaches a predetermined value, which is greater than the mechanical load experienced in method step z) by the component assembly ready for further processing.

Also disclosed, on the basis of the curable adhesive compound according to the invention and the adhesive tape according to the invention, is the use of a curable adhesive compound according to the invention or adhesive tape according to the invention for bonding two or more components by curing of the curable adhesive compound, preferably in a method according to the invention.

The invention and preferred embodiments of the invention are further explained and described below, with reference to experiments.

### A. Production of the Curable Adhesive Compounds:

From the constituents summarized in table 1, curable adhesive compounds were obtained by mixing the components in a customary manner (as laboratory drawdowns from a 40% butanone solution).

TABLE 1
Composition of the curable adhesive compounds;
all data in parts by weight

| | I1 | I2 | I3 | I4 | C1 | C2 |
|---|---|---|---|---|---|---|
| Levamelt 700 | 10 | 40 | 40 | 40 | 40 | 40 |
| D.E.R. 331 | 60 | 30 | 30 | 30 | 30 | 30 |
| D.E.R. 662E | 20 | 20 | 20 | 20 | 20 | 20 |
| Capa 2054 | 10 | 10 | 10 | 10 | 10 | 10 |
| Methyl violet | 0.2 | 0.2 | 0.1 | — | — | 0.5 |
| Methyl yellow | — | — | — | 0.1 | — | — |
| Sudan Blue II, | — | — | — | — | 0.2 | — |
| CAS: 17354-14-2 | | | | | | |
| Triarylsulfonium | 3 | 3 | 3 | 3 | 3 | 2 |
| hexafluorophosphate | | | | | | |
| (50% in propylene carbonate) | | | | | | |

The (co-)polymer used was the commercially available ethylene-vinyl acetate copolymer Levamelt® 700 (vinyl acetate content of 70 percent by weight) from Arlanxeo.

Epoxy compounds used were a commercially available solid bisphenol A diglycidyl ether (D.E.R. 662E) and a commercially available liquid bisphenol A diglycidyl ether (D.E.R. 331) from Olin.

The cationic initiator used was triarylsulfonium hexafluorophosphate (50% in propylene carbonate; CAS: 109037-77-6; the indication of the initial weight in table 1 refers to the solution).

The polyol used was a commercially available polyester polyol based on polycaprolactone (Capa 2054) from Ingevity.

Adhesive tapes with a thickness of about 100 μm were produced by drawdowns from the curable adhesive compounds produced, for the solid curable adhesive compounds 12, 13 and 14.

### B. Bonding Experiments & Color Rating:

### Peel Adhesion:

The peel adhesion forces were determined in analogy to ISO 29862 (Method 3) at 23 °C and 50% relative humidity at a peeling speed of 300 mm/min and a peel angle of 180°. The thickness of the adhesive layer was 100 μm in each case. An etched PET film of 50 μm in thickness such as is obtainable from Coveme (Italy) was used as reinforcing film. Steel plates according to the standard were used as substrate. The uncured measuring strip was bonded using a roll-on machine with 4 kg at a temperature of 23 °C The adhesive tapes were peeled off immediately after application. The measured value (in N/cm) was the average of three individual measurements and the failure mode was documented as follows: adhesive failure (A) or cohesive failure (C).

### Bond Strength:

The bond strength was determined in each case quantitatively in a dynamic tensile shear test in accordance with DIN EN 1465: 2009 July at 23 °C and 50% relative humidity for a test speed of 1 mm/min (results in N/mm²=MPa). The test rods used were made of steel, and were cleaned with acetone before bonding.

The layer thicknesses of the adhesive tapes for the solid curable adhesive compounds 12, 13 and 14 each corresponded to the above specifications. Before the test rods were assembled and after removal of the second liner, the adhesive tapes were irradiated with suitable light (Honle 365 nm LED lamp with a UV-A dose of 3000 mJ/cm²) and the test specimens were assembled immediately after. The liquid curable adhesive compound 11 was applied as a formless adhesive with a layer thickness of 100 μm (as is customary for testing liquid adhesives, a few glass balls with a particle size of 100 μm were scattered into the bondline as spacers). Before the test rods were assembled, the curable adhesive compound was irradiated with suitable light (Honle 365 nm LED lamp with a UV-A dose of 3000 mJ/cm²) and the test specimens were assembled immediately after. The bond strength was measured after a change in colour was detected. In order to determine the relative bond strength, moreover, the maximum bond strength achievable by the cationic curing was determined on fully cured samples after 7 d. For 12, for example, this was 8.9 MPa.

The results are summarized in table 2.

TABLE 2
Summary of the bonding experiments

| | I1 | I2 | I3 | I4 | C1 | C2 |
|---|---|---|---|---|---|---|
| Fracture mode* / | C | A | A | A | A | A |
| Peel adhesion | (n.d.) | (>1 N/cm) | (>1 N/cm) | (>1 N/cm) | (>1 N/cm) | (>1 N/cm) |
| Color change | from | from | from | from | from | greenish, |
| | yellowish- | yellowish- | yellowish- | red/orange | pink to | remains |
| | green to | green to | green to | to yellow | purple | greenish |
| | blue | blue | blue | | | |
| Bond strength ratio | 45% | 60% | 52% | 78% | 92% | does not |
| β at change in color | | | | | | cure |

*A: adhesive failure; C: cohesive failure

From the fracture mode in the peel adhesion test, an advantageous cohesion and pressure-sensitive adhesive properties can be identified for samples 12 to 14. As expected, the liquid adhesive compound 11 shows a cohesive failure before curing, so that no meaningful peel adhesion can be determined.

The observed change in color is a change in color that is within the expected interval of the relative bond strength, where in most cases immediately after irradiation a further change in color is evident, which advantageously indicates the successful irradiation, but for which the relative bond strengths will in any case still be outside the interval.

The tensile shear tests after curing show that the adhesive compounds according to the invention cure and in the process, at the color change, bond strengths can be achieved which are between 45% and 78% of the respective maximum achievable bond strength, so that through the color change it can be reliably indicated that component assemblies bonded with corresponding curable adhesive compounds can already be supplied to further processing without fear of a failure of the bond. Thus, in a production process which comprises such bonding, the cycling and thus the production rate can be increased in an advantageous manner.

In contrast to these examples according to the invention, when using unsuitable dyes, the change in color occurs only on almost full curing (C1). If the dye-to-initiator ratio is too large, as shown by way of example in C2, i.e., too much dye is used, the adhesive compound no longer cures properly.

1. A curable adhesive compound, comprising:
a) one or more (co)polymers,
b) one or more polymerizable epoxy compounds,
c) one or more cationic initiators, and
d) one or more pH color indicators with at least one pH-dependent color change,
wherein the mass ratio of the combined mass of the cationic initiators to the combined mass of the pH color indicators in the curable adhesive compound is 5:1 or more, and
wherein the curable adhesive compound has a composition such that a pH-dependent color change of the one or more pH color indicators takes place during the cationic curing of the curable adhesive compound at a time at which the bond strength of the curing adhesive compound is in the range from 20% to 80% of the maximum bond strength achievable by the cationic curing.

2. The curable adhesive compound according to claim 1, wherein the one or more pH color indicators have a pH-dependent color change at a pH of 4 or less.

3. The curable adhesive compound according to claim 1, wherein the one or more pH color indicators are selected from the group consisting of: cresol red, methyl violet, crystal violet, ethyl violet, malachite green, methyl green, ethyl green, 2-(p-dimethylaminophenylazo)pyridine, metanil yellow, 4-phenylazodiphenylamine, thymol blue, metacresol purple, 4-[(4-anilinophenyl)azo]benzenesulfonic acid sodium salt, 4-o-tolylazo-o-toluidine, 2,2′,2″,4,4′-pentamethoxytriphenylmethanol, quinaldine red, erythrosine disodium salt, 4,4′-bis(2-amino-1-naphthylazo)-2,2′-stilbenedisulfonic acid and methyl yellow.

4. The curable adhesive compound according to claim 1, wherein the combined mass fraction of the pH color indicators in the curable adhesive compound is in the range from 0.01% to 0.4%, based on the mass of the curable adhesive compound.

5. The curable adhesive compound according to claim 1, wherein the combined mass fraction of the cationic indicators in the curable adhesive compound is in the range from 0.1% to 7%, based on the mass of the curable adhesive compound.

6. The curable adhesive compound according to claim 1, wherein the mass ratio of the combined mass of the cationic initiators to the combined mass of the pH color indicators in the curable adhesive compound is 6:1 or more.

7. The curable adhesive compound according to claim 1, wherein the combined mass fraction of the (co)polymers in the curable adhesive compound is in the range from 1% to 70%, based on the mass of the curable adhesive compound.

8. The curable adhesive compound according to claim 1, wherein the combined mass fraction of the polymerizable epoxy compounds in the curable adhesive compound is in the range from 35% to 95%, based on the mass of the curable adhesive compound.

9. The curable adhesive compound according to claim 1, wherein the curable adhesive compound is a pressure-sensitive adhesive compound.

10. The curable adhesive compound according to claim 1, wherein the curable adhesive compound has a composition such that a pH-dependent color change of the one or more pH color indicators takes place during the cationic curing of the curable adhesive compound at a time at which the bond strength of the curing adhesive compound is in the range from 25% to 75% of the maximum bond strength achievable by the cationic curing.

11. An adhesive tape, comprising as adhesive layer a curable adhesive compound according to claim 1.

12. A method of connecting two or more components before carrying out further processing steps, comprising the method steps of:
w) producing or providing an adhesive tape as claimed in claim 11,
x) connecting two or more components with the adhesive tape and initiating the cationic curing of the curable adhesive compound by activating the one or more cationic initiators, to give a component assembly,
y) curing the curable adhesive compound until the color change of the one or more pH color indicators, to give a component assembly ready for further processing with an as yet incompletely cured curable adhesive compound, and
z) carrying out one or more further processing steps on the component assembly ready for further processing.
